(19) United States
(12) Patent Application Publication
(10) Pub. No.: US 2007/0262205 A1
(43) Pub. Date: Nov. 15, 2007

(54) RETRACTABLE MULTIPLE WINGLET

(76) Inventor: Roger Hugh Grant, APO, AP (US)

Correspondence Address: Roger Grant, PSC 80, BOX 10652, APO, AP, 96367, US

(21) Appl. No.: 11/382,283

(22) Filed: May 9, 2006

(51) Int. Cl. B64C 23/06

(52) U.S. Cl. 244/199.2

(57) ABSTRACT

Unlike conventional winglets that attempt to block out wingtip vortices, these winglets use multiple airfoils to recycle much of the energy of these vortices back into useful lift and thrust (drag reduction). This will improve the lift to drag ratio at high angles of attack. These airfoils extend outward in the plane of the wing from each wingtip and are specially shaped to make them easy to extend and retract. Not only can they function over a continuum of airspeeds and angles of attack, but they can also be fully retracted at very high speeds to avoid parasite drag penalties.

### BACKGROUND OF THE INVENTION

One of the main problems for aircraft flying at low speeds is the increase in induced drag due to wingtip vortices. This induced drag is proportionate to the inverse of the velocity squared. This problem is traditionally alleviated by using fixed winglets but these can be a liability at high speeds because they increase the wetted area and thus increase the parasite drag. As a result, virtually all wing designs either present a compromise between high speed and low speed efficiency, or sacrifice one for the other.

A device that can reduce the wingtip vortices at low speeds or high angles of attack while being able to retract for high speeds or low angles of attack would present distinct benefits. Additionally, if the degree of extension can be varied along a continuum throughout various airspeeds or angles of attack, that would be even more beneficial.

### BRIEF SUMMARY OF THE INVENTION

Wingtip vortices are produced by high pressure air at the bottom of the wing traveling around the tips to reach the low pressure air at the upper surfaces of the wing. This creates a localized upwash in the region immediately outboard of each wingtip. This upwash decreases in strength as the point of measurement moves farther outboard away from the wingtip. Small airfoils (winglets) that extend outward into this upwash could recycle much of this energy back into usable lift and (to a lesser degree) thrust while reducing the strength of the vortex. This will add to the overall lift of the wing while the resultant thrust will decrease the induced drag. Both of these combined will significantly increase the lift to drag ratio at high angles of attack. This is consistent with the laws of conservation of energy and momentum.

These winglets will be partially and fully retractable on a continuum based on the optimum setting for the angle of attack or speed. This can potentially optimize their performance for high speed, low speed and every point in between. It can also be useful to high performance aircraft that have to maneuver throughout a wide range of airspeeds and angles of attack.

### BRIEF DESCRIPTION OF THE DRAWINGS

FIG. 1A shows a supercritical airfoil at a high angle of attack. The straight arrow at the right represents the relative wind direction at a point that is too far from the wing to be influenced by it. The undulating arrows show the air at the bottom of the wing escaping around the wingtip to the top of the wing. This airflow is the beginning of a wingtip vortex.

FIG. 1B shows a supercritical airfoil of the same shape as in FIG. 1A but with the addition of retractable multiple winglets. These winglets are represented by the contours of airfoil shapes that are superimposed on the supercritical airfoil. As in FIG. 1A, the straight arrow at the right represents the relative wind at a great distance from the wing. The arrows that curve around the profiles of the smaller airfoils represent the airflow around these airfoils. The straight but forward leaning arrows pointing out the top of the small airfoils represent the resultant forces that are induced upon these airfoils. This shows an addition to lift and a reduction in drag.

FIG. 2A shows the top view of the most outboard portion of a right wing. The leading edge is facing the right of the page and the winglets are fully retracted for very high speed flight.

FIG. 2B shows the same view of the same wing as in FIG. 2A. However, this time the winglets are partially extended for moderate speed flight.

FIG. 2C shows the same view of the same wing as in FIG. 2A. However, this time the winglets are fully extended for low speed or high angle of attack flight.

FIG. 3 shows the general shape of one of these winglets. The leading edge of the inboard portion has a much greater negative incidence than that of the outboard portion to accommodate the stronger upwash. Also, all cross sectional areas are able to fit within the “footprint” of the innermost cross section to allow for easy retraction and extension. This results in each winglet having a slight sweep.

### DETAILED DESCRIPTION OF THE INVENTION

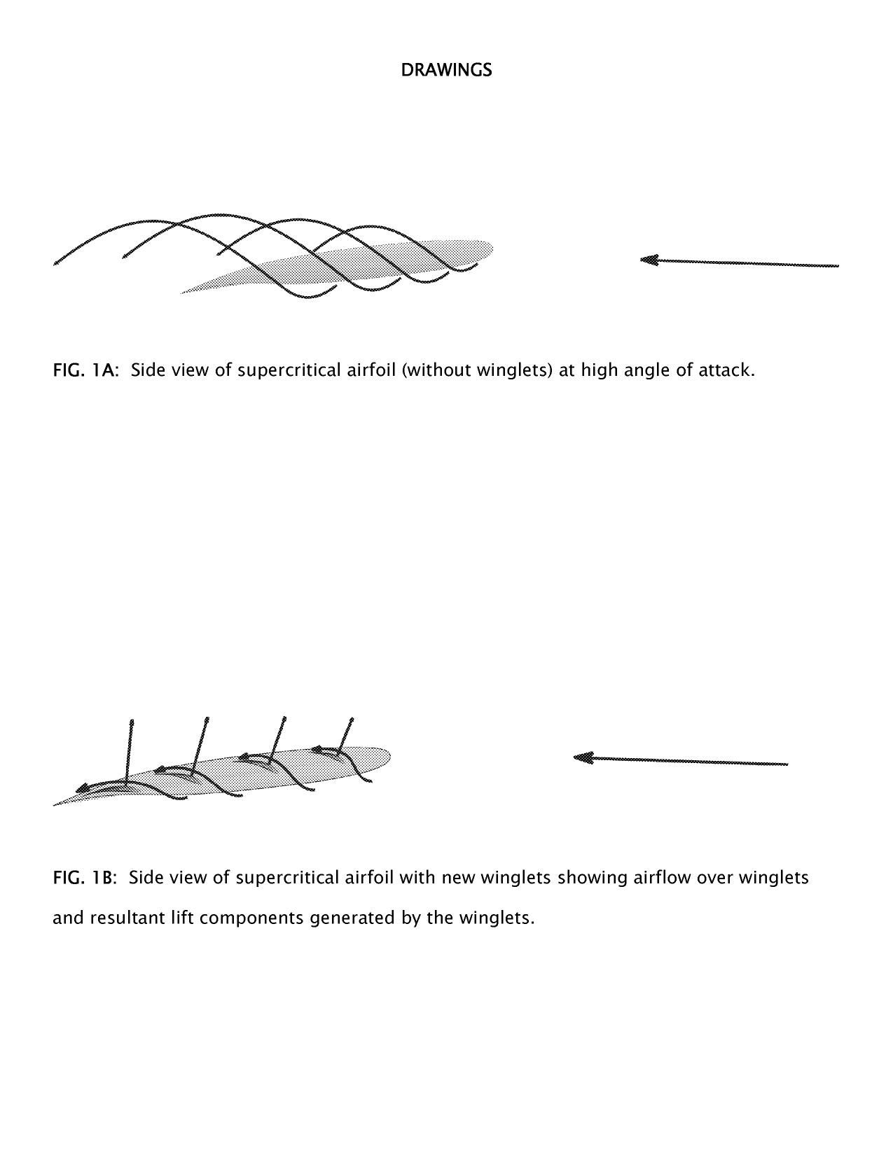

As illustrated in FIG. 1A, an airfoil that produces lift will have some high pressure air from the bottom of the wing escaping around the wingtip to the top of the wing. This creates a strong upwash immediately outboard of the wingtip as well as a powerful vortex at the trailing edge of the wingtip. FIG. 1B shows what happens when airfoils are placed in this upwash. Because the upwash is causing the local airflow to travel at an upward angle, the airfoils must be tilted forward (leading edge down) to meet the airflow at the proper angle. This will cause the resultant lift vector of the airfoils to be tilted forward and slightly into the direction of the relative wind (as illustrated). Not only will this create a lift component that will add to the overall lift of the wing, but it will also create a thrust component that will reduce the overall drag. This increase in lift and reduction in drag will significantly improve the lift to drag ratio at high angles of attack. In accordance with the laws of conservation of energy and momentum, the downwash created by the winglets opposes the upwash and reduces its strength as well as the strength of the vortex.

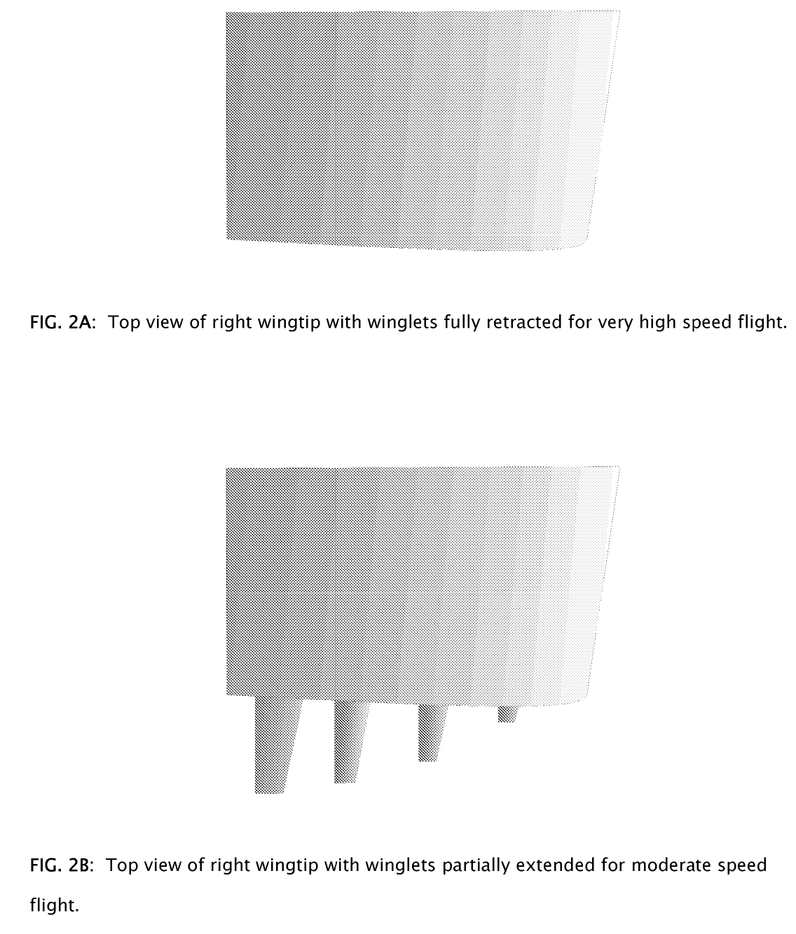

Conventional winglets extend upward or downward from the wingtips to act as fences by attempting to block out the wingtip vortices. Although this configuration works well at low speeds and high angles of attack, the benefit drops off at higher speeds and lower angles of attack where wingtip vortices are naturally weaker. These can even be a detriment at very high speeds where the parasite drag that they create increases with the velocity squared. This invention uses airfoils that extend outward from the wingtips in the same plane as the wings. This allows them to be fully retractable without excessive complexity. At very high speeds and low angles of attack, these winglets can be fully retracted because they are not needed and to avoid the drag penalties (see FIG. 2A). At moderate speeds, they can be partially extended (see FIG. 2B) to decrease some of the induced drag without adding too much parasite drag. At low speeds and high angles of attack, the winglets can be fully extended (see FIG. 2C) to lower the induced drag without too much concern about parasite drag. The amount of extension can be varied on a continuum throughout the airspeed envelope and not just at a finite number of airspeeds.

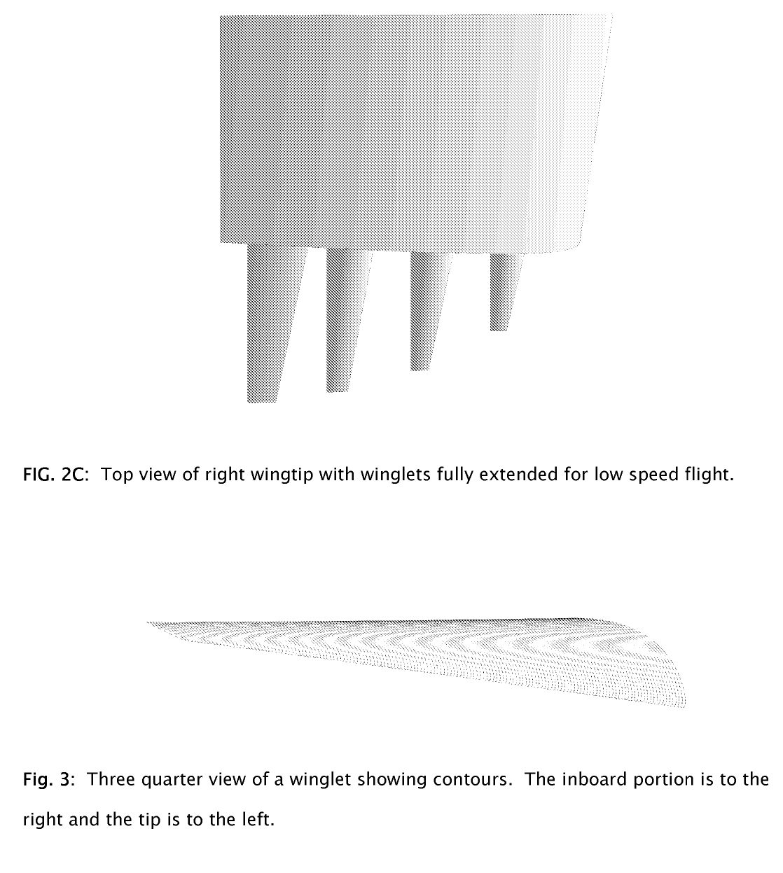

Wingtip vortices are strongest near the wingtip and they become weaker as the location moves farther outboard away from the wingtip. According to the Biot-Savart Law as it applies to aerodynamics, the induced vertical component of the velocity is inversely proportional to the distance from the wingtip (theoretically). As a result, the negative incidence at the leading edge of the winglets must be less extreme for the outboard portions than for the inboard portions. The overall shapes of the winglets in this invention accommodate this requirement as illustrated in FIG. 3. In addition, each winglet is designed so that the cross section along any portion will fit into the cross sectional area (“footprint”) of the root of the winglet. This will allow the winglets to be fully retractable without having to twist the winglets or the wing itself.

What is claimed is:

1. Multiple winglets extending outward directly into the upwash that is immediately outboard of a lift producing wing so that they recycle some of the upwash energy back into usable lift and thrust (reduced drag) with the effect of increasing the lift to drag ratio.

2. Making the winglets in claim 1 fully retractable so that the amount of extension can potentially be optimized for the varying airspeeds or angles of attack throughout the flight envelope.

3. Making the winglets in claim 1 have a greater negative incidence at the inboard portions than at the tips to accommodate for the stronger upwash that is present at the inboard portions.

4. Adjusting the sweep and taper ratio of the tips of the winglets in claim 1 so that they have the changing incidence as per claim 3 while being fully retractable as per claim 2 without the need for twisting or otherwise warping the winglets.
